(19) United States
(12) Patent Application Publication
(10) Pub. No.: US 2021/0316955 A1
(43) Pub. Date: Oct. 14, 2021

(54) CUTTING DEVICE, POST-PROCESSING APPARATUS, AND IMAGE FORMING SYSTEM

(71) Applicants: Yuusuke SHIBASAKI, Kanagawa (JP); Yuji SUZUKI, Kanagawa (JP)

(72) Inventors: Yuusuke SHIBASAKI, Kanagawa (JP); Yuji SUZUKI, Kanagawa (JP)

(73) Assignee: Ricoh Company, Ltd., Tokyo (JP)

(21) Appl. No.: 17/226,217

(22) Filed: Apr. 9, 2021

(30) Foreign Application Priority Data
Apr. 14, 2020 (JP) 2020-072583

(51) Int. Cl. B65H 35/00; B65H 43/00

(52) U.S. Cl. CPC B65H 35/0086; B65H 43/00

(57) ABSTRACT

A cutting device is configured to cut, in an arc shape, an end of a sheet conveyed in a conveyance direction. The cutting device includes an arc-shaped cutting blade; a switching mechanism; and a contact-and-separation mechanism. The switching mechanism is configured to switch a posture of the cutting blade in accordance with a position of the sheet facing the cutting blade. The contact-and-separation mechanism is configured to bring the cutting blade into contact with the sheet in a contact direction orthogonal to a surface of the sheet and away from the sheet in a separation direction opposite the contact direction, to cut the end of the sheet in the arc shape.

### CROSS-REFERENCE TO RELATED APPLICATION

This patent application is based on and claims priority pursuant to 35 U.S.C. § 119(a) to Japanese Patent Application No. 2020-072583, filed on Apr. 14, 2020, in the Japan Patent Office, the entire disclosure of which is incorporated by reference herein.

### BACKGROUND

### Technical Field

Embodiments of the present disclosure relate to a cutting device, a post-processing apparatus, and an image forming system.

### Related Art

There has been known a post-processing apparatus that performs post-processing on a sheet on which an image is formed by an image forming apparatus. Specific examples of post-processing include a punching process for punching holes in sheets, an end stitching process for bundling a plurality of sheets and stitching their ends, a saddle stitching process for performing saddle stitching, and a chamfering process for chamfering the ends of the sheets.

There is a known a configuration of a post-processing apparatus that performs a chamfering process, where a pair of cutting blades separated in the width direction orthogonal to the sheet conveying direction are projected toward the sheet to cut the ends of the sheet with respect to the width direction in an arc shape (hereinafter, described as “chamfering”).

### SUMMARY

In an aspect of the present disclosure, there is provided a cutting device is configured to cut, in an arc shape, an end of a sheet conveyed in a conveyance direction. The cutting device includes an arc-shaped cutting blade; a switching mechanism; and a contact-and-separation mechanism. The switching mechanism is configured to switch a posture of the cutting blade in accordance with a position of the sheet facing the cutting blade. The contact-and-separation mechanism is configured to bring the cutting blade into contact with the sheet in a contact direction orthogonal to a surface of the sheet and away from the sheet in a separation direction opposite the contact direction, to cut the end of the sheet in the arc shape.

### BRIEF DESCRIPTION OF THE DRAWINGS

The aforementioned and other aspects, features, and advantages of the present disclosure would be better understood by reference to the following detailed description when considered in connection with the accompanying drawings, wherein:

FIG. 1 is a side view illustrating an overall outline of an image forming system according to a first embodiment;

FIG. 2 is a schematic view illustrating an internal structure of a post-processing apparatus;

FIG. 3 is a plan view of a cutting device according to the first embodiment;

FIG. 4 is a view of the cutting device according to the first embodiment as viewed from the conveyance direction;

FIG. 5 is a view of the cutting device according to the first embodiment as viewed from the width direction;

FIG. 6 is a view of the cutting unit as viewed from the width direction;

FIG. 7 is a view of the cutting unit as viewed from the conveyance direction;

FIG. 8 is a plan view of the cutting unit;

FIG. 9 is a diagram illustrating a hardware configuration of the post-processing apparatus;

FIG. 10 is a flowchart of a chamfering process;

FIGS. 11A to 11F are diagrams illustrating a positional relationship between a sheet M and the cutting units in each phase of the first half of the chamfering process;

FIGS. 12A to 12E are diagrams illustrating a positional relationship between the sheet M and the cutting units in each phase of the second half of the chamfering process;

FIGS. 13A and 13B are flowcharts illustrating steps S1005 and S1008 according to a second embodiment of the chamfering process illustrated in FIG. 10;

FIGS. 14A to 14F are diagrams illustrating a positional relationship between a sheet M and cutting units in each phase of a chamfering process according to the second embodiment;

FIG. 15 is a plan view of a cutting device according to a third embodiment;

FIG. 16 is a view of the cutting device according to the third embodiment as viewed from the conveyance direction;

FIG. 17 is a view of the cutting device according to the third embodiment as viewed from the width direction;

FIGS. 18A to 18C are flowcharts illustrating steps S1003, S1004, and S1007 according to the third embodiment of the chamfering process illustrated in FIG. 10;

FIGS. 19A to 19F are diagrams illustrating a positional relationship between a sheet M and cutting units in each phase of a chamfering process according to the third embodiment;

FIG. 20 is a plan view of a cutting device according to a fourth embodiment;

FIGS. 21A to 21C are diagrams illustrating a positional relationship between a sheet M and cutting units in each phase of a chamfering process according to the fourth embodiment;

FIGS. 22A and 22B are flowcharts illustrating steps S1005 and S1008 according to a fifth embodiment of the chamfering process illustrated in FIG. 10;

FIGS. 23A to 23D are diagrams illustrating a positional relationship between a sheet M and cutting units in each phase of the chamfering process according to the fifth embodiment;

FIGS. 24A to 24D are diagrams illustrating variations in the shape of a cutting blade;

FIG. 25 is a flowchart illustrating step S1005 according to a sixth embodiment of the chamfering process illustrated in FIG. 10; and

FIGS. 26A to 26D are diagrams illustrating a positional relationship between a sheet M and a cutting unit in each phase of the chamfering process according to the sixth embodiment. The accompanying drawings are intended to depict embodiments of the present disclosure and should not be interpreted to limit the scope thereof. The accompanying drawings are not to be considered as drawn to scale unless explicitly noted.

### DETAILED DESCRIPTION OF EMBODIMENTS

In describing embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner and achieve similar results. Although the embodiments are described with technical limitations with reference to the attached drawings, such description is not intended to limit the scope of the disclosure and all of the components or elements described in the embodiments of this disclosure are not necessarily indispensable. Referring now to the drawings, embodiments of the present disclosure are described below. In the drawings for explaining the following embodiments, the same reference codes are allocated to elements (members or components) having the same function or shape and redundant descriptions thereof are omitted below.

### First Embodiment

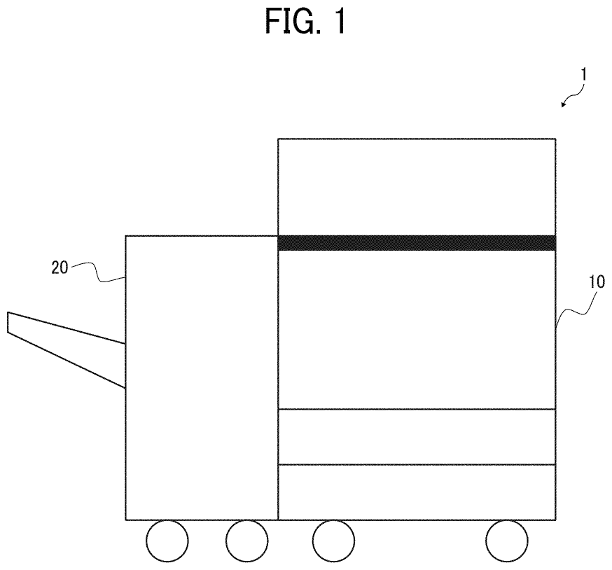

Hereinafter, an image forming system 1 according to the first embodiment will be described with reference to the drawings. FIG. 1 is a side view illustrating an overall outline of the image forming system 1 according to the first embodiment. The image forming system 1 continuously forms an image on a plurality of sheets M. As illustrated in FIG. 1, the image forming system 1 mainly includes an image forming apparatus 10 and a post-processing apparatus 20.

The sheets M as sheet-like media refer to every medium to which ink or toner are stuck to form an image and that can be conveyed in a curved form, such as paper (paper sheets), overhead projector (OHP) sheets, threads, fibers, cloth, leather, metal, or plastic.

The image forming apparatus 10 forms an image on the sheets M. Then, the image forming apparatus 10 discharges the sheets M on which the image is formed to the post-processing apparatus 20. The image forming apparatus 10 mainly includes a paper feeding tray as a sheet accommodating unit that accommodates the plurality of sheets M in a stacked state, a conveyance unit as a sheet paper feeding/conveyance unit, and an image forming unit that forms an image on the sheets conveyed by the conveyance unit.

The conveyance unit feeds the sheets M contained in the paper feed tray and conveys the sheets M along a conveyance path provided inside the image forming apparatus 10. The conveyance path is a path from the paper feed tray to the post-processing apparatus 20 through a position facing the image forming unit. The image forming unit forms an image on the sheets conveyed by the conveyance unit. The specific configuration of the image forming unit is not particularly limited, and may be an inkjet type or an electrophotographic type.

The post-processing apparatus 20 performs post-processing on the sheets M on which the image is formed by the image forming apparatus 10. The post-processing apparatus 20 according to the present embodiment performs at least a chamfering process in which to cut the ends of the sheets M in an arc shape (hereinafter, referred to as “chamfering”). However, the post-processing executed by the post-processing apparatus 20 is not limited to the chamfering process but may include a punching process for punching holes in the sheets, an end stitching process for bundling a plurality of sheets and stitching the ends of the sheets, and a saddle stitching for performing saddle stitching.

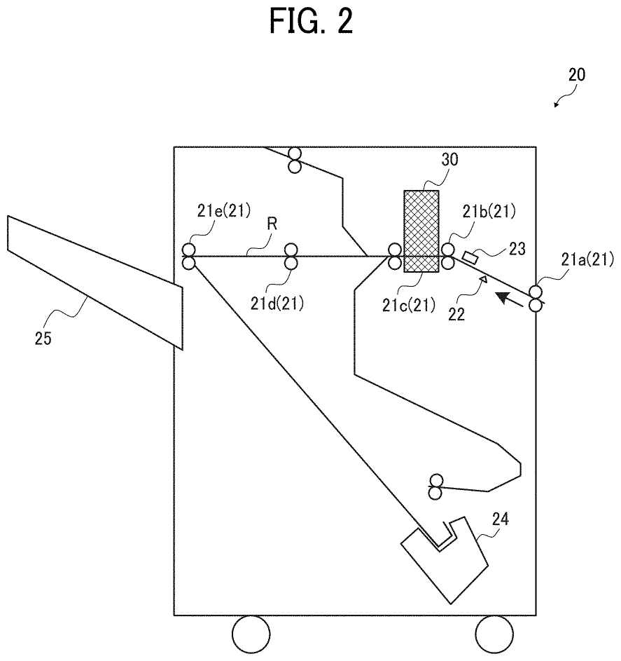

FIG. 2 is a schematic view illustrating an internal structure of the post-processing apparatus 20. As illustrated in FIG. 2, the post-processing apparatus 20 mainly includes a conveyance unit 21 as a conveyor, a reference sensor 22, a line sensor 23, an end stitching machine 24, a paper ejection tray 25, and a cutting device 30 (chamfering device).

The conveyance unit 21 conveys the sheets M supplied from the image forming apparatus 10 along a conveyance path R inside the post-processing apparatus 20. One end of the conveyance path R is connected to the image forming apparatus 10, and the other end is connected to the paper ejection tray 25 via positions facing the reference sensor 22, the line sensor 23, and the cutting device 30.

The conveyance unit 21 includes a plurality of roller pairs 21a, 21b, 21c, 21d, and 21e. The roller pairs 21a to 21e are arranged along the conveyance path R. Each of the roller pairs 21a to 21e includes a driving roller that rotates with the driving force of a motor and a driven roller that is driven by the rotation of the driving roller. The driving roller and the driven roller rotate with the sheet M sandwiched therebetween to convey the sheet along the conveyance path R in the conveyance direction (direction from the image forming apparatus 10 toward the paper ejection tray 25).

The roller pair 21a is arranged on the upstream side of the reference sensor 22 and the line sensor 23 in the conveyance direction. The roller pair 21b is arranged on the downstream side of the reference sensor 22 and the line sensor 23 in the conveyance direction, and on the upstream side of the cutting device 30 in the conveyance direction. The roller pair 21c is arranged on the downstream side of the cutting device 30 in the conveyance direction. The roller pair 21d is arranged on the downstream side of the roller pair 21c in the conveyance direction. The roller pair 21e is arranged on the downstream side of the roller pair 21d in the conveyance direction.

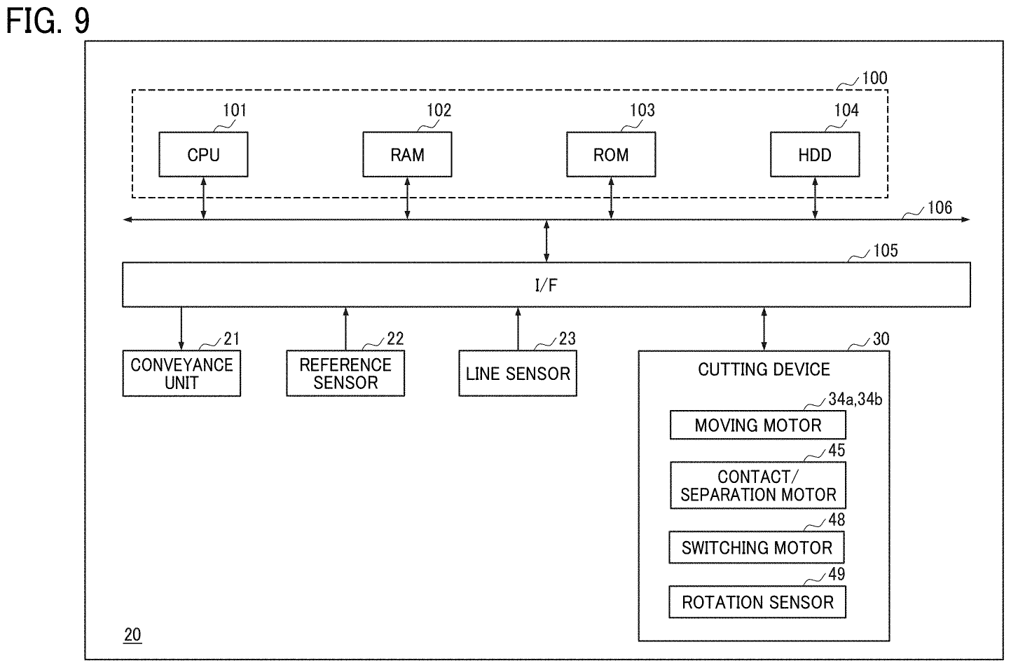

The reference sensor 22 is arranged on the downstream side of the roller pair 21a in the conveyance direction and on the upstream side of the line sensor 23 in the conveyance direction. The reference sensor 22 detects that the sheet M has passed the installation position, and outputs a detection signal indicating the detection result to the controller 100 (see FIG. 9) described later. More particularly, the reference sensor 22 does not output a detection signal when the sheet M is not present at the installation position (hereinafter, this state will be referred to as “reference sensor 22 is OFF”). On the other hand, the reference sensor 22 outputs a detection signal when the sheet M is present at the installation position (hereinafter, this state will be referred to as “reference sensor 22 is ON”).

That is, the reference sensor 22 starts outputting the detection signal at the timing when the front end of the sheet M reaches the installation position. In other words, when the front end of the sheet M reaches the installation position, the reference sensor 22 switches from OFF to ON. On the other hand, the reference sensor 22 stops the output of the detection signal at the timing when the rear end of the sheet M passes the installation position. In other words, when the rear end of the sheet M passes the installation position, the reference sensor 22 switches from ON to OFF.

The line sensor 23 is arranged on the downstream side of the reference sensor 22 in the conveyance direction and on the upstream side of the roller pair 21b in the conveyance direction. The line sensor 23 is arranged too far to one side from the center of the conveyance path R in the width direction orthogonal to the conveyance direction. Then, the line sensor 23 detects the end face position of the sheet M in the width direction conveyed along the conveyance path R, and outputs a detection signal indicating the detection result to the controller 100.

More particularly, the line sensor 23 includes a plurality of sensors arranged in the width direction. Among the plurality of sensors, the sensor facing the sheet M outputs a detection signal, and the sensor not facing the sheet M does not output a detection signal. That is, the controller 100 can determine the boundary position between the sensor that outputs the detection signal and the sensor that does not output the detection signal as the end face position of the sheet M in the width direction.

The specific configurations of the reference sensor 22 and the line sensor 23 are not particularly limited, but for example, a transmission type optical sensor and a reflection type optical sensor can be adopted.

The end stitching machine 24 executes an end stitching process of bundling a plurality of sheets M and stitching the ends of the sheets M. When the roller pair 21e sandwiching the sheet M therebetween reversely rotates, the sheet M is supplied to the end stitching machine 24. The end stitching machine 24 bundles the plurality of sheets M supplied by the roller pair 21e and stitches the ends of the sheets M. The paper ejection tray 25 stacks and supports the sheets M discharged from the roller pair 21e.

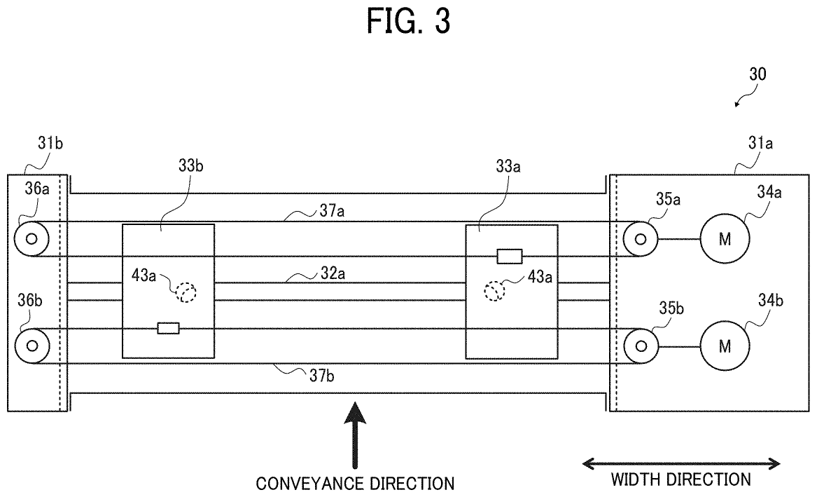

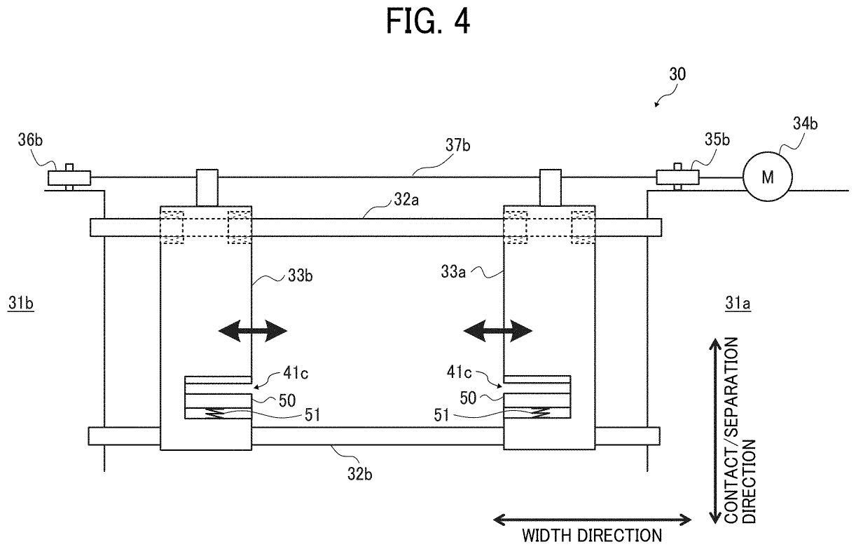

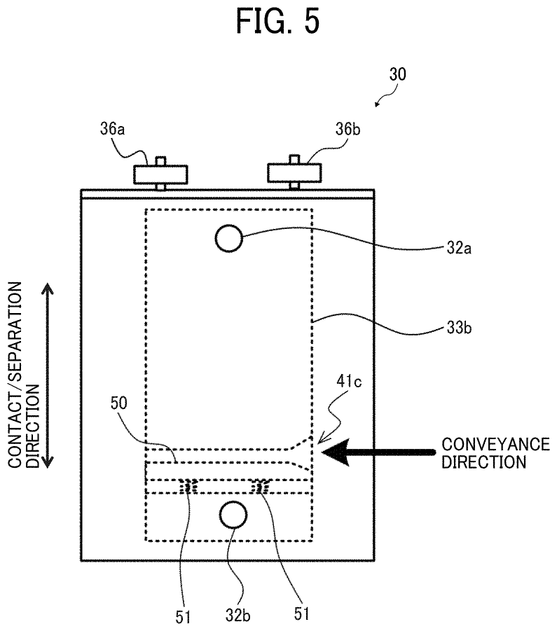

FIG. 3 is a plan view of the cutting device 30 according to the first embodiment. FIG. 4 is a view of the cutting device 30 according to the first embodiment as viewed from the conveyance direction. FIG. 5 is a view of the cutting device 30 according to the first embodiment as viewed from the width direction. The cutting device 30 is a device that cuts the end portions of the sheet M conveyed by the conveyance unit 21 in an arc shape. Here, the end portion of the sheet M refers not only to the four corners of the sheet M but also to an arbitrary position on sides constituting the outer shape of the sheet M.

In this specification, the left and right sides are defined so as to face the downstream side in the conveyance direction of the sheet M. In the first embodiment, the “right end” in FIG. 3 is an example of “one end”, and the “left end” in FIG. 3 is an example of “the other end”. Further, in the first embodiment, the “vertical direction” is an example of the “contact or separation direction” orthogonal to the surface of the sheet M. However, each direction is not limited to the above-mentioned example.

As illustrated in FIGS. 3 to 5, the cutting device 30 mainly includes side plates 31a and 31b, guide shafts 32a and 32b, cutting units 33a and 33b, moving motors 34a and 34b, driving pulleys 35a and 35b, driven pulleys 36a and 36b, and timing belts 37a and 37b.

The side plates 31a and 31b are supported by the frame of the post-processing apparatus 20. The side plates 31a and 31b are arranged so as to sandwich the conveyance path R at positions separated in the width direction. That is, the sheet M conveyed in the conveyance path R passes between the side plates 31a and 31b.

The guide shafts 32a and 32b each have one end supported by the side plate 31a, and the other end supported by the side plate 31b, and extend in the width direction. The guide shafts 32a and 32b are arranged so as to sandwich the conveyance path R at positions separated in the vertical direction. That is, the sheet M conveyed in the conveyance path R passes between the guide shafts 32a and 32b.

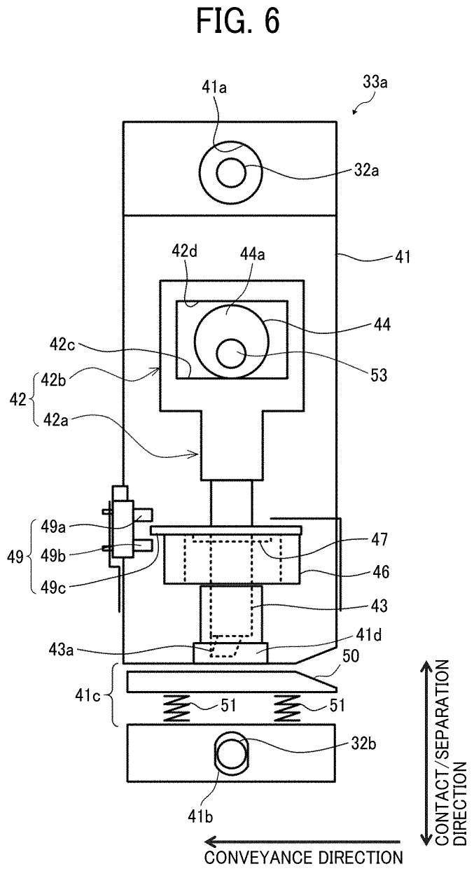

The cutting units 33a and 33b are units that cut the end portion of the sheet M in an arc shape. The cutting units 33a and 33b are supported by the guide shafts 32a and 32b and are movable in the width direction. The cutting unit 33a is arranged on one end side in the width direction (on the right side in the example of FIG. 3). The cutting unit 33b is arranged on the other end side in the width direction (left side in the example of FIG. 3). The configurations of the cutting units 33a and 33b will be described later with reference to FIGS. 6 to 8.

The moving motors 34a and 34b generate a driving force for moving the cutting units 33a and 33b in the width direction. The driving pulleys 35a and 35b are supported by the side plate 31a, and are rotated with the transferred driving force of the moving motors 34a and 34b. The driven pulleys 36a and 36 are supported by the side plate 31b, and are rotated with the driving force of the moving motors 34a and 34b transferred through the timing belts 37a and 37b. The timing belts 37a and 37b are endless annular belts hung between the driving pulleys 35a and 35b and the driven pulleys 36a and 36b.

The timing belt 37a is connected to the cutting unit 33a. Therefore, the cutting unit 33a reciprocates in the width direction along the guide shafts 32a and 32b with the driving force of the moving motor 34a transferred through the timing belt 37a. The timing belt 37b is connected to the cutting unit 33b. Therefore, the cutting unit 33b reciprocates in the width direction along the guide shafts 32a and 32b with the driving force of the moving motor 34b transferred through the timing belt 37b.

That is, the moving motor 34a, the driving pulley 35a, the driven pulley 36a, and the timing belt 37a are examples of moving mechanism that move the cutting unit 33a in the width direction. The moving motor 34b, the driving pulley 35b, the driven pulley 36b, and the timing belt 37b are examples of moving mechanism that move the cutting unit 33b in the width direction. In this way, the moving mechanisms can move the cutting units 33a and 33b independently of each other.

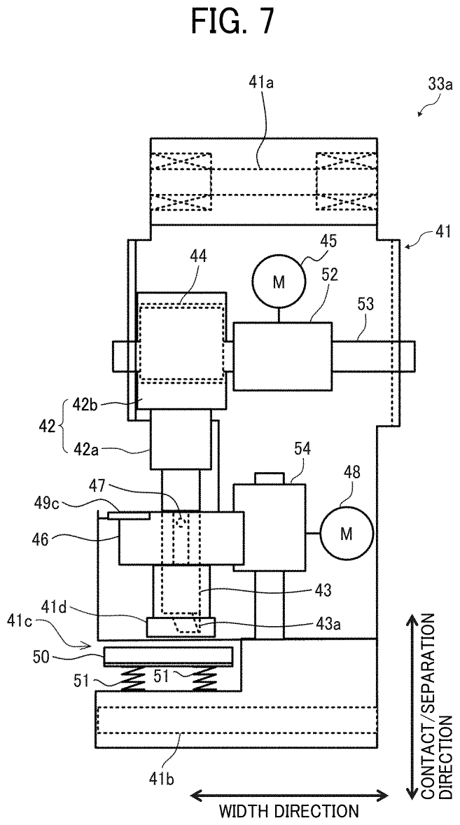

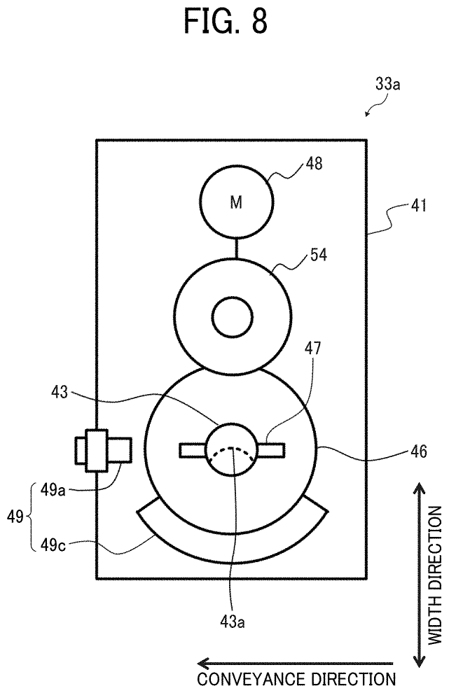

FIG. 6 is a view of the cutting unit 33a as viewed from the width direction. FIG. 7 is a view of the cutting unit 33a as viewed from the conveyance direction. FIG. 8 is a plan view of the cutting unit 33a. Since the configurations of the cutting units 33a and 33b are common, only the cutting unit 33a will be described in detail below. As illustrated in FIGS. 6 to 8, the cutting unit 33a mainly includes a frame 41, a cam guide 42, a blade body 43, a cam 44, a contact-and-separation motor 45, a rotary gear 46, a pin 47, a switching motor 48, a rotation sensor 49, a receiving plate 50, and a coil spring 51.

The frame 41 constitutes the outer shell of the cutting unit 33a. The frame 41 is a housing including an internal space for accommodating the components 42 to 49 of the cutting unit 33a. The upper part of the frame 41 has a through hole 41a into which the guide shaft 32a is inserted via a linear bush. The lower part of the frame 41 has a through hole 41b into which the guide shaft 32b is inserted via a linear bush. The frame 41 has a recess 41c at a position corresponding to the conveyance path R. The frame 41 has a burring-processed through hole 41d on the top surface defining the recess 41c.

The cam guide 42 is housed in the internal space of the frame 41 so as to be movable in the vertical direction. The cam guide 42 has a holding portion 42a for holding the blade body 43 and a frame 42b for accommodating the cam 44.

The blade body 43 has a substantially cylindrical outer shape. An arc-shaped cutting blade 43a is formed at the tip of the blade body 43. The cutting blade 43a has a fan shape with a central angle of 90°. The blade body 43 is held by the holding portion 42a of the cam guide 42 with the cutting blade 43a facing downward. The blade body 43 is held by the holding portion 42a via a bearing so as to be rotatable around a rotation axis extending in the axial direction (that is, the vertical direction) of the cylinder. The cutting blade 43a of the blade body 43 held by the holding portion 42a faces the through hole 41d of the frame 41.

The cam 44 is housed in the frame 42b of the cam guide 42. The cam 44 rotates around a drive shaft 53 extending in the horizontal direction with the driving force of the contact-and-separation motor 45 transferred through the drive gear 52. A cam lobe (cam ridge) 44a is formed on a part of the outer peripheral surface of the cam 44 in the circumferential direction. Then, when the cam lobe 44a comes into contact with the bottom surface 42c of the frame 42b, the cam guide 42 moves downward. On the other hand, when the cam lobe 44a comes into contact with the top surface 42d of the frame 42b, the cam guide 42 moves upward. That is, when the contact-and-separation motor 45 is rotationally driven, the cam guide 42 moves up and down periodically according to the position of the cam lobe 44a.

The blade body 43 moves up and down together with the cam guide 42. Then, when the blade body 43 moves downward, the cutting blade 43a projects into the recess 41c through the through hole 41d. As a result, the cutting blade 43a comes into contact with the sheet M passing the recess 41c (that is, the conveyance path R). On the other hand, when the blade body 43 moves upward, the cutting blade 43a is sunk in the internal space of the frame 41 through the through hole 41d. As a result, the cutting blade 43a is separated from the sheet M passing the recess 41c (that is, the conveyance path R). The cam guide 42, the cam 44, the contact-and-separation motor 45, the drive gear 52, and the drive shaft 53 are an example of the contact-and-separation mechanism that brings the cutting blade 43a into contact with and away from the sheet M.

The rotary gear 46 has a ring-shaped outline. When the blade body 43 is inserted into the rotary gear 46, the rotary gear 46 is integrated with the blade body 43 by a pin 47. The rotary gear 46 rotates together with the blade body 43 around the rotation axis extending in the vertical direction, with the driving force of the switching motor 48 transferred through the drive gear 54. As a result, the posture of the cutting blade 43a (orientation of the arc) is switched. The rotary gear 46, the switching motor 48, and the drive gear 54 are an example of switching mechanism that switches the posture of the cutting blade 43a.

The rotation sensor 49 is an example of a rotation angle detector that detects the rotation angle of the blade body 43 (in other words, the cutting blade 43a). The rotation sensor 49 includes, for example, a light emitting unit 49a, a light receiving unit 49b, and a shielding plate 49c. The light emitting unit 49a and the light receiving unit 49b face each other in the vertical direction. The shielding plate 49c protrudes outward in the radial direction from a part of the outer peripheral surface of the rotary gear 46, and has a predetermined length in the circumferential direction. Then, as the rotary gear 46 rotates, the shielding plate 49c enters into between the light emitting unit 49a and the light receiving unit 49b, and exits from between the light emitting unit 49a and the light receiving unit 49b.

When the shielding plate 49c does not exist between the light emitting unit 49a and the light receiving unit 49b, the light output from the light emitting unit 49a is received by the light receiving unit 49b. At this time, the rotation sensor 49 outputs a detection signal to the controller 100. On the other hand, when the shielding plate 49c exists between the light emitting unit 49a and the light receiving unit 49b, the light output from the light emitting unit 49a is blocked by the shielding plate 49c and is not received by the light receiving unit 49b. At this time, the rotation sensor 49 does not output a detection signal to the controller 100.

The receiving plate 50 is supported on the bottom surface defining the recess 41c via a coil spring 51. The receiving plate 50 supports the sheet M passing the recess 41c from below. The cutting blade 43a protruding from the through hole 41d moves further downward even after contact with the sheet M. At this time, the coil spring 51 is elastically compressed, so that the receiving plate 50 is pressed downward. As a result, the cutting blade 43a is pressed against the sheet M. and the end portion of the sheet M is cut in an arc shape. On the other hand, when the cutting blade 43a is sunk in the internal space of the frame 41 through the through hole 41d, the coil spring 51 elastically returns and the receiving plate 50 returns to its original position.

FIG. 9 is a diagram illustrating a hardware configuration of the post-processing apparatus 20. The post-processing apparatus 20 includes a central processing unit (CPU) 101 as a control device or control circuitry, a random access memory (RAM) 102 as a storage device, a read only memory (ROM) 103 as a storage device, a hard disk drive (HDD) 104 as a storage device, and an interface (I/F) 105 as an interface, which are connected via a common bus 106 as a communication device. The CPU 101, the RAM 102, the ROM 103, and the HDD 104 are examples of the controller 100.

The CPU 101 is an arithmetic unit and controls the operations of the entire post-processing apparatus 20. The RAM 102 is a volatile storage medium capable of reading and writing information at high speed, and is used as a work area for the CPU 101 to process the information. The ROM 103 is a read-only non-volatile storage medium, and stores programs such as firmware. The HDD 104 is anon-volatile storage medium capable of reading and writing information and having a large storage capacity, and stores an operating system (OS), various control programs, application programs, and the like.

The post-processing apparatus 20 processes control programs stored in the ROM 103 and information processing programs (application programs) loaded into the RAM 102 from a storage medium such as the HDD 104 by an arithmetic function provided in the CPU 101. The processing constitutes software control units including various functional modules of the post-processing apparatus 20. The combination of the software control unit configured in this way and the hardware resources mounted on the post-processing apparatus 20 constitutes functional blocks that implement the functions of the post-processing apparatus 20.

The I/F 105 is an interface for connecting the conveyance unit 21, the reference sensor 22, the line sensor 23, and the cutting device 30 to the common bus 106. That is, the controller 100 controls the conveyance unit 21, the reference sensor 22, the line sensor 23, and the cutting device 30 through the I/F 105.

More particularly, the controller 100 determines the position of the sheet M on the conveyance path R by combining a detection signal from the reference sensor 22 and a pulse signal from a rotary encoder included in the motor of the conveyance unit 21. That is, the combination of the reference sensor 22 and the rotary encoder in the motor of the conveyance unit 21 is an example of sheet position detector that detects the position of the sheet M conveyed by the conveyance unit 21.

The controller 100 also determines the posture of the cutting blade 43a (that is, the rotation angle of the cutting blade 43a) by the combination of a detection signal from the rotation sensor 49 and a pulse signal from a rotary encoder included in the switching motor 48. That is, the combination of the rotation sensor 49 and the rotary encoder of the switching motor 48 is an example of rotation angle detector that detects the rotation angle of the cutting blade 43a.

The controller 100 also determines the positions of the cutting units 33a and 33b in the width direction by pulse signals from the rotary encoders mounted on the moving motors 34a and 34b. The controller 100 further determines the position of the cutting blade 43a in the vertical direction by a pulse signal from a rotary encoder included in the contact-and-separation motor 45.

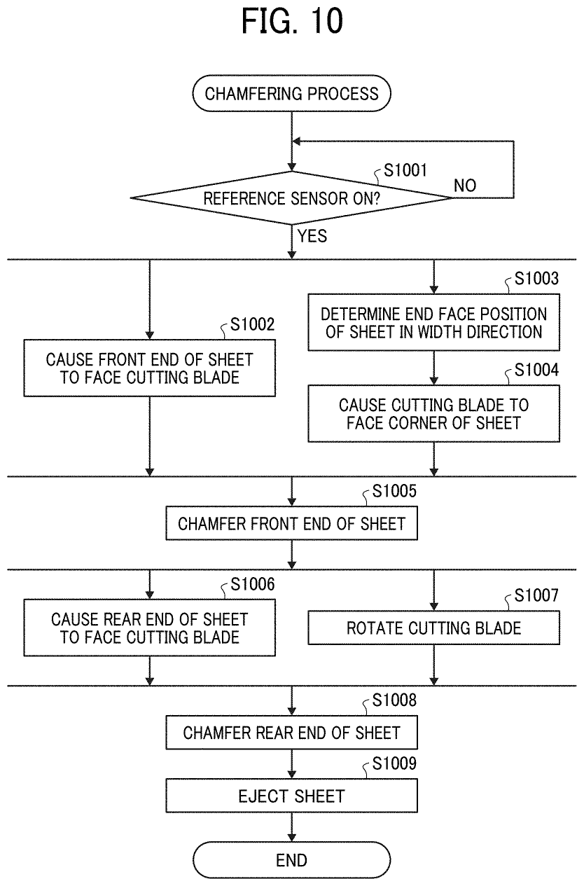

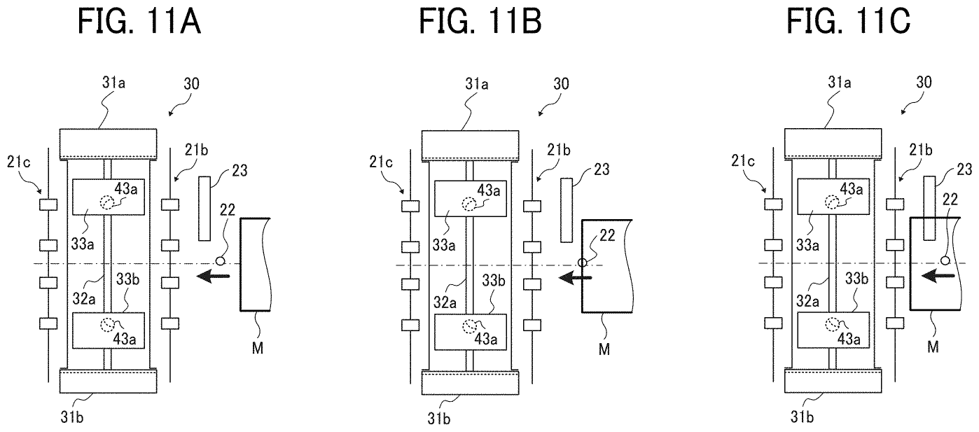

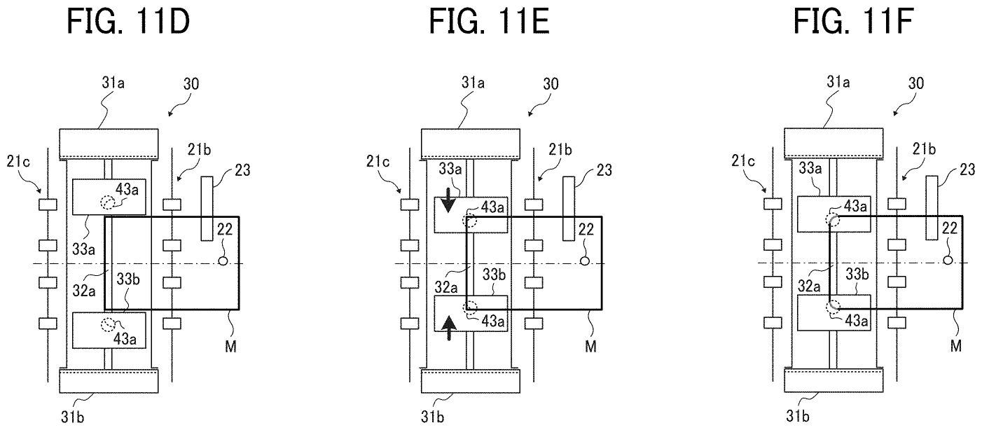

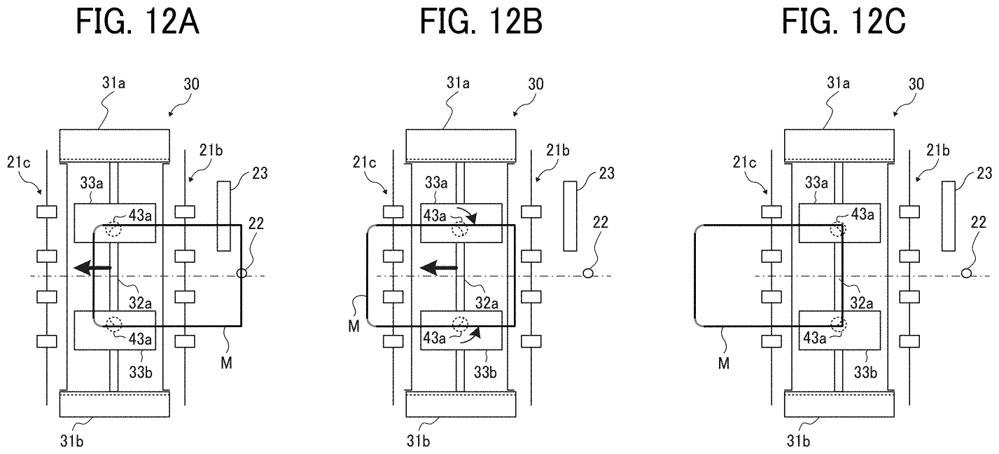

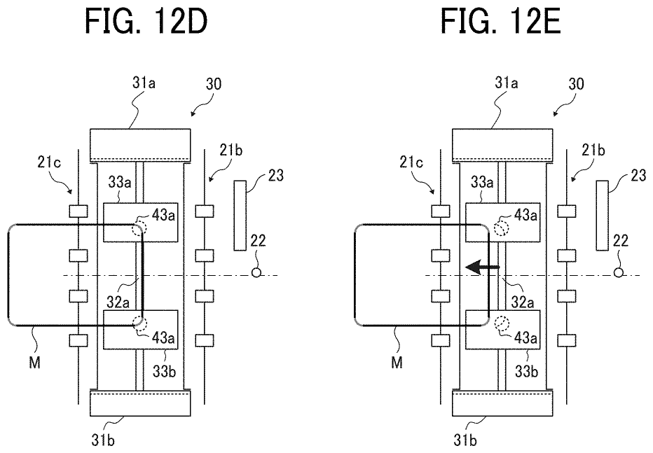

Next, the chamfering process will be described with reference to FIGS. 10 to 12E. FIG. 10 is a flowchart of the chamfering process. FIGS. 11A to 11F are diagrams illustrating a positional relationship between the sheet M and the cutting units 33a and 33b in each phase of the first half of the chamfering process. FIGS. 12A to 12E are diagrams illustrating a positional relationship between the sheet M and the cutting units 33a and 33b in each phase of the second half of the chamfering process. The controller 100 executes the chamfering process illustrated in FIG. 10 on each of the sheets M supplied from the image forming apparatus 10.

Based on the results of detection by the reference sensor 22 and the rotary encoder in the motor of the conveyance unit 21, the controller 100 conveys the sheet M by the conveyance unit 21 so that the cutting position of the sheet M faces the cutting blade 43a. Based on the results of detection by the rotation sensor 49, the controller 100 switches the posture of the cutting blade 43a by the switching mechanism so that the posture corresponds to the cutting position. The controller 100 brings the cutting blade 43a in the posture corresponding to the cutting position into contact with and away from the sheet M by the contact-and-separation mechanism. Hereinafter, each step of the chamfering process will be described in detail with reference to FIGS. 10 to 12E.

By driving the motor of the conveyance unit 21, the controller 100 rotates the roller pairs 21a to 21e in the direction of conveying the sheet M in the conveyance direction. Then, the controller 100 waits until the reference sensor 22 starts outputting the detection signal (that is, the reference sensor 22 turns on) (S1001: No). Then, when the sheet M reaches the position illustrated in FIG. 11B through the position illustrated in FIG. 11A, the reference sensor 22 turns from OFF to ON.

Next, at the timing when the reference sensor 22 turns on (S1001: Yes), the controller 100 starts counting the number of pulse signals output from the rotary encoder in the motor of the conveyance unit 21. Then, at the timing when the number of counted pulse signals reaches a threshold pulse number, the controller 100 stops the conveyance of the sheet M by the conveyance unit 21 (S1002). The threshold pulse number is a predetermined number corresponding to the distance from the installation position of the reference sensor 22 to the position facing the cutting blade 43a. Accordingly, as illustrated in FIG. 11D, the sheet M is conveyed to a position where the front end of the sheet M faces the cutting blade 43a. At this time, the sheet M is sandwiched by the roller pair 21b.

Further, as illustrated in FIG. 11C, when the sheet M faces the line sensor 23, the controller 100 determines the end face position (right end position) of the sheet M in the width direction based on the detection signal output from the line sensor 23 (S1003). Then, as illustrated in FIG. 11E, the controller 100 drives the moving motors 34a and 34b based on the determined end face position in the width direction to cause the cutting blade 43a of the cutting unit 33a to face the right end of the sheet M, and cause the cutting blade 43a of the cutting unit 33b to face the left end of the sheet M (S1004). It is assumed that the left end position of the sheet M and the right end position of the sheet M are symmetrical with respect to the center of the conveyance path R.

Step S1003 is executed in the process of executing step S1002. On the other hand, step S1004 may be executed in the process of executing step S1002, or may be executed after step S1002 is completed. That is, the controller 100 may execute steps S1002 and S1004 in parallel or in order.

As illustrated in FIGS. 11A to 11D, the cutting blade 43a (first cutting blade) of the cutting unit 33a is set in advance in a first posture in which to chamfer the right corner of the front end (hereinafter, referred to as “front right corner”) of the sheet M. The first posture is a posture in which the cutting blade 43a is located inside the front right corner of the sheet M and becomes convex toward the front right corner. More particularly, the first posture is a posture in which one end of the arc-shaped cutting blade 43a connects to the side of the front end of the sheet M and the other end connects to the side of the right end of the sheet M.

As illustrated in FIGS. 11A to 11D, the cutting blade 43a (second cutting blade) of the cutting unit 33b is set in advance in a third posture in which to chamfer the left corner of the front end (hereinafter, referred to as “front left corner”) of the sheet M. The third posture is a posture in which the cutting blade 43a is located inside the front left corner of the sheet M and becomes convex toward the front left corner. More particularly, the third posture is a posture in which one end of the arc-shaped cutting blade 43a connects to the side of the front end of the sheet M and the other end connects to the side of the left end of the sheet M.

When both steps S1002 and S1004 are completed, as illustrated in FIG. 11F, the cutting blade 43a of the cutting unit 33a faces the front right corner of the sheet M, and the cutting blade 43a of the cutting unit 33b faces the front left corner of the sheet M. Therefore, the controller 100 drives the contact-and-separation motor 45 until the cam 44 makes one rotation (S1005). As a result, the respective cutting blades 43a of the cutting units 33a and 33b come into contact with the sheet M and separate again from the sheet M, thereby chamfering the front right corner and the front left corner of the sheet M.

Next, the controller 100 causes the conveyance unit 21 to restart the conveyance of the sheet M. As illustrated in FIG. 12A, when the rear end of the sheet M passes the position of the reference sensor 22, the reference sensor 22 turns from ON to OFF. At the timing when the reference sensor 22 turns from ON to OFF, the controller 100 starts counting the number of pulse signals output from the rotary encoder in the motor of the conveyance unit 21. At the timing when the number of counted pulse signals reaches a threshold pulse number, the controller 100 stops the conveyance of the sheet M by the conveyance unit 21 (S1006).

Accordingly, as illustrated in FIG. 12C, the sheet M is conveyed to a position where the rear end of the sheet M faces the cutting blade 43a. At this time, the sheet M is sandwiched by the roller pair 21c. More particularly, the cutting blade 43a of the cutting unit 33a faces the right corner of the rear end (hereinafter, referred to as “rear right corner”) of the sheet M, and the cutting blade 43a of the cutting unit 33b faces the left corner of the rear end (hereinafter, referred to as “rear left corner”) of the sheet M.

Further, as illustrated in FIG. 12B, the controller 100 rotates the cutting blades 43a by driving the respective switching motors 48 of the cutting units 33a and 33b (S1007). More particularly, the controller 100 brings the cutting blade 43a of the cutting unit 33a into the second posture in which to chamfer the rear right corner of the sheet M, and brings the cutting blade 43a of the cutting unit 33b into a fourth posture in which to chamfer the rear left corner of the sheet M.

The second posture is a posture in which the cutting blade 43a is located inside the rear right corner of the sheet M and becomes convex toward the rear right corner. More specifically, the second posture is a posture in which one end of the arc-shaped cutting blade 43a connects to the side of the rear end of the sheet M and the other end connects to the side of the right end of the sheet M. That is, the controller 100 switches from the first posture to the second posture by rotating the cutting blade 43a of the cutting unit 33a clockwise by 90°.

The fourth posture is a posture in which the cutting blade 43a is located inside the rear left corner of the sheet M and becomes convex toward the rear left corner. More specifically, the fourth posture is a posture in which one end of the arc-shaped cutting blade 43a connects to the side of the rear end of the sheet M and the other end connects to the side of the left end of the sheet M. That is, the controller 100 switches from the third posture to the fourth posture by rotating the cutting blade 43a of the cutting unit 33b counterclockwise by 90°.

Step S1007 may be executed in the process of executing step S1006, or may be executed after step S1006 is completed. That is, the controller 100 may execute steps S1006 and S1007 in parallel or in order.

Next, when both steps S1006 and S1007 are completed, the controller 100 drives the contact-and-separation motor 45 until the cam 44 makes one rotation, as illustrated in FIG. 12D (S1008). As a result, the respective cutting blades 43a of the cutting units 33a and 33b come into contact with the sheet M and separate again from the sheet M, thereby chamfering the rear right corner and the rear left corner of the sheet M.

Next, as illustrated in FIG. 12E, the controller 100 ejects the sheet M to the paper ejection tray 25 by causing the conveyance unit 21 to restart the conveyance of the sheet M (S1009). Then, the controller 100 ends the chamfering process at the timing when the sheet M is ejected to the paper ejection tray 25.

According to the first embodiment, the following operational effects, for example, are achieved.

According to the first embodiment, the sheets M of various sizes can be chamfered by moving the cutting units 33a and 33b in the width direction. By rotating the cutting blade 43a, the cutting unit 33a can chamfer the front right corner and the rear right corner of the sheet M, and the cutting unit 33b can chamfer the front left corner and the rear left corner of the sheet M. As a result, any end of the sheet M can be chamfered with the simple configuration.

### Second Embodiment

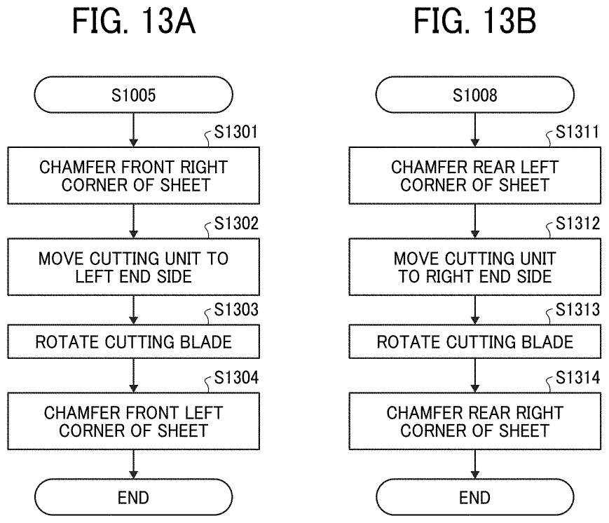

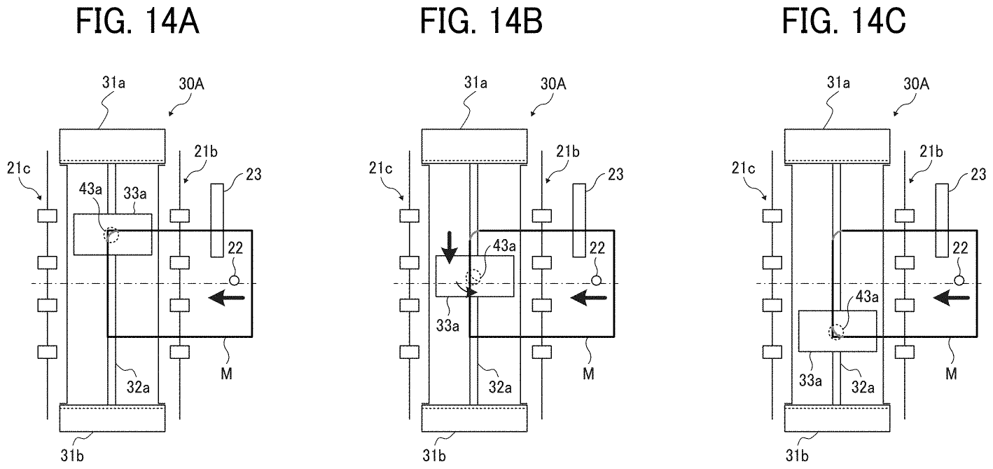

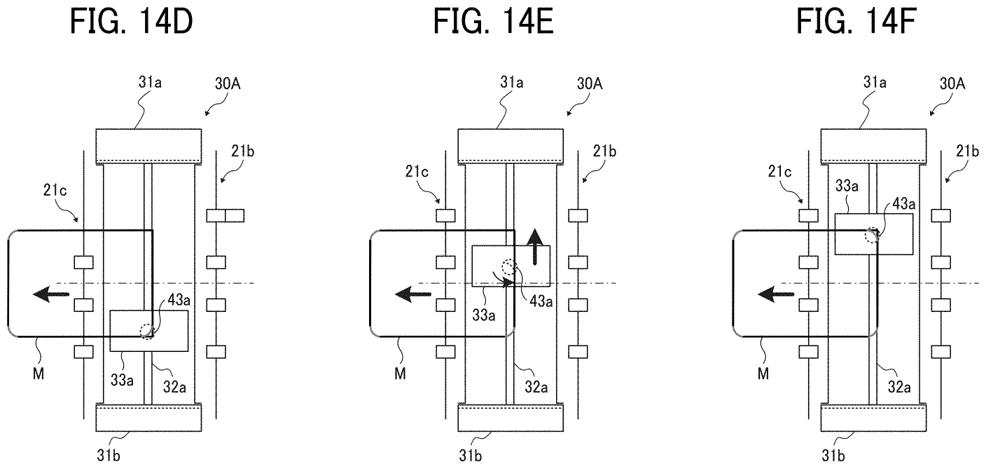

Next, a chamfering process according to a second embodiment will be described with reference to FIGS. 13A to 14F. FIGS. 13A and 13B are flowcharts illustrating steps S1005 and S1008 according to a second embodiment of the chamfering process illustrated in FIG. 10. FIGS. 14A to 14F are diagrams illustrating a positional relationship between a sheet M and a cutting unit 33a in each phase of the chamfering process according to the second embodiment. The detailed description of points in common with the first embodiment will be omitted, and the differences will be mainly described.

A cutting device 30A according to the second embodiment is different from the first embodiment in that a cutting unit 33b is omitted, and is the same as the first embodiment in other respects. In the chamfering process according to the second embodiment, steps S1005 and S1008 are different from the first embodiment, and other steps S1001 to S1004, S1006 and S1007, and S1009 are in common with the first embodiment.

In step S1005 of FIG. 10, a controller 100 according to the second embodiment executes steps S1301 to S1304 illustrated in FIG. 13A. At the timing when steps S1001 to S1004 in FIG. 10 are completed, a cutting blade 43a of the cutting unit 33a faces the front right corner of the sheet M and is in the first posture.

First, as illustrated in FIG. 14A, the controller 100 chamfers the front right corner of the sheet M with the cutting blade 43a by driving a contact-and-separation motor 45 (S1301). Next, as illustrated in FIG. 14B, the controller 100 moves the cutting unit 33a toward the left end side by driving the moving motor 34a (S1302). Further, the controller 100 switches the cutting blade 43a from the first posture to the third posture by driving a switching motor 48 (S1303). Next, as illustrated in FIG. 14C, the controller 100 chamfers the front left corner of the sheet M with the cutting blade 43a by driving the contact-and-separation motor 45 (S1304).

Further, in step S1008 of FIG. 10, the controller 100 according to the second embodiment executes steps S1311 to S1314 illustrated in FIG. 13B. At the timing when steps S1006 to S1007 in FIG. 10 are completed, the cutting blade 43a of the cutting unit 33a faces the rear left corner of the sheet M and is in the fourth posture.

First, as illustrated in FIG. 14D, the controller 100 chamfers the rear left corner of the sheet M with the cutting blade 43a by driving the contact-and-separation motor 45 (S1311). Next, as illustrated in FIG. 14E, the controller 100 moves the cutting unit 33a toward the right end side by driving the moving motor 34a (S1312). Further, the controller 100 switches the cutting blade 43a from the fourth posture to the second posture by driving the switching motor 48 (S1313). Next, as illustrated in FIG. 14F, the controller 100 chamfers the rear right corner of the sheet M with the cutting blade 43a by driving the contact-and-separation motor 45 (S1314).

According to the second embodiment, by rotating the cutting blade 43a counterclockwise by 90°, the front right corner, front left corner, rear left corner, and rear right corner of the sheet M can be chamfered in this order with one cutting blade 43a. That is, the four corners of the sheet M can be chamfered with the structure further simpler than that of the first embodiment. The controller 100 may execute steps S1302 and S1303 in parallel or in order. Similarly, the controller 100 may execute steps S1312 and S1313 in parallel or in order.

### Third Embodiment

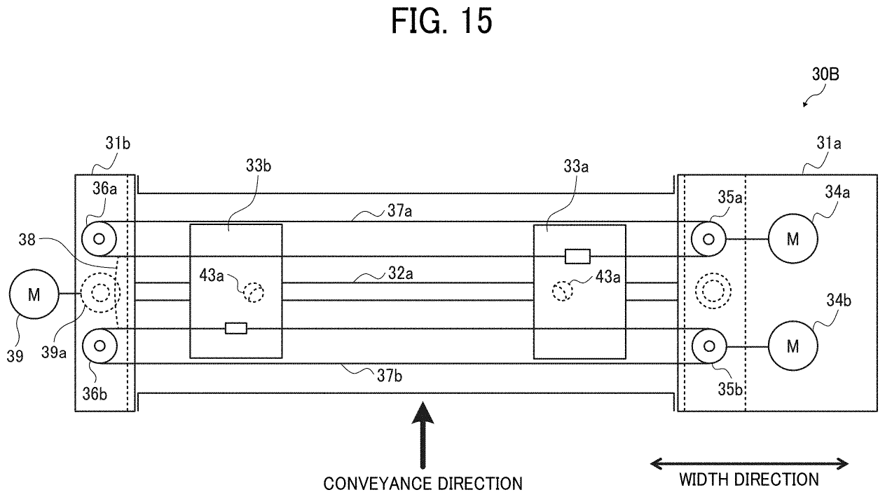

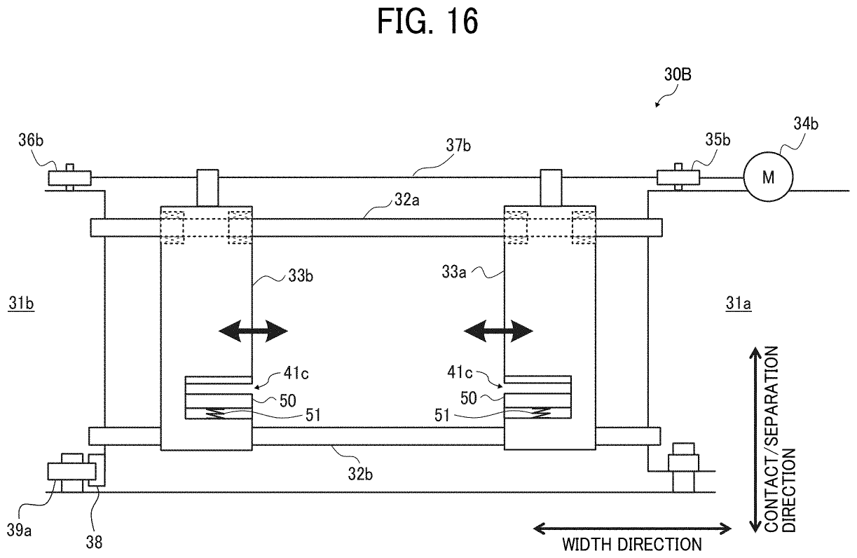

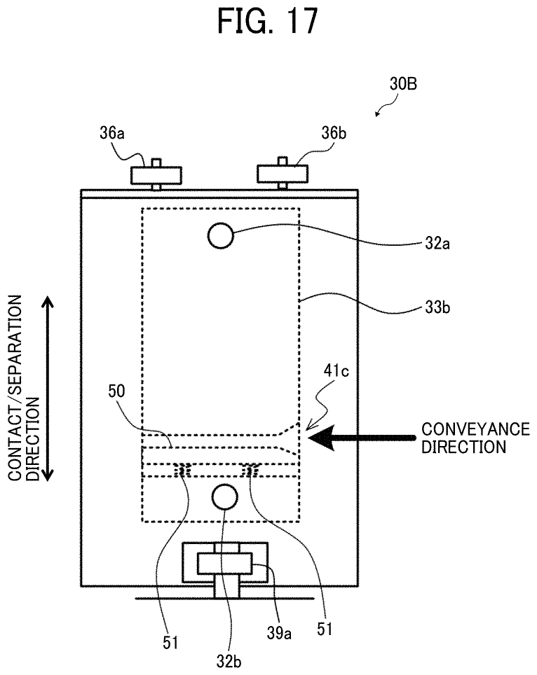

Next, a cutting device 30B according to a third embodiment will be described with reference to FIGS. 15 to 19F. FIG. 15 is a plan view of the cutting device 30B according to the third embodiment. FIG. 16 is a view of the cutting device 30B according to the third embodiment as viewed from the conveyance direction. FIG. 17 is a view of the cutting device 30B according to the third embodiment as viewed from the width direction. The detailed description of points in common with the first embodiment will be omitted, and the differences will be mainly described. The cutting device 30B according to the third embodiment is different from the first embodiment in further including a rotating mechanism, and is the same as the first embodiment in other respects.

The cutting device 30B according to the third embodiment further includes a rotary gear 38 and a rotary motor 39. In addition, guide shafts 32a and 32b according to the third embodiment are supported by a side plate 31a via a bearing so as to be rotatable around a rotation axis extending in the vertical direction. The rotary gear 38 is attached to the other ends of the guide shafts 32a and 32b. The driving force of the rotary motor 39 is transmitted to the rotary gear 38 through the drive gear 39a.

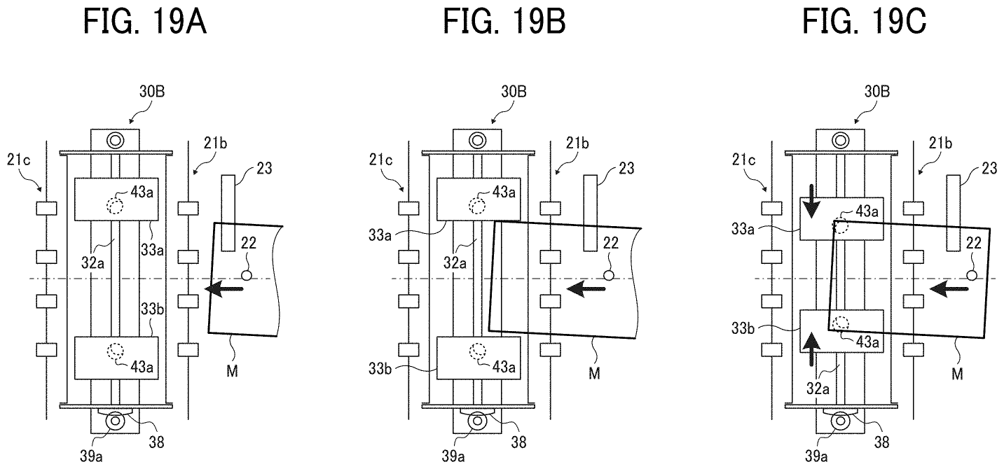

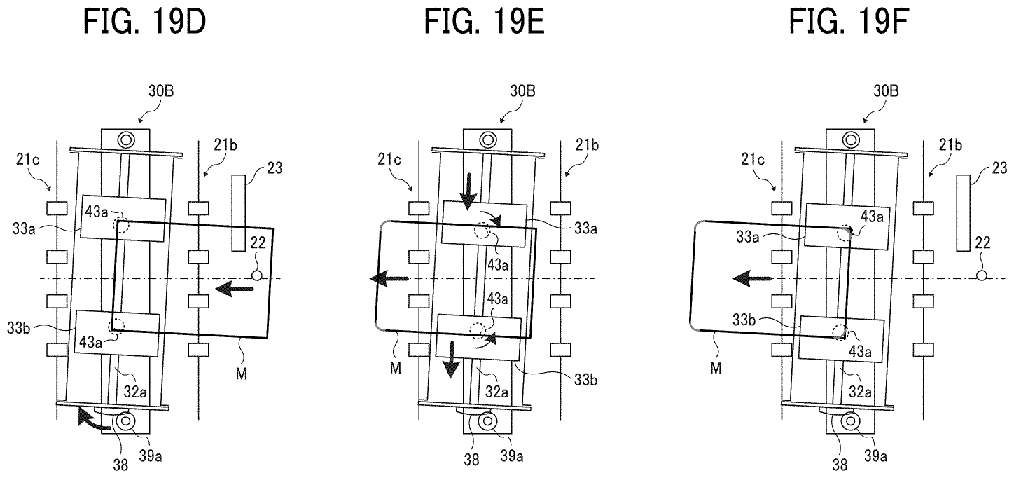

As a result, as illustrated in FIG. 19D, the guide shafts 32a and 32b each rotate on a plane parallel to the surface of the sheet M, with one end (the end near the side plate 31a) as the rotation center and the other end (the end near the side plate 31b) as the rotation tip. Then, the cutting units 33a and 33b are tilted as the guide shafts 32a and 32b rotate. The rotary gear 38, the rotary motor 39, and the drive gear 39a are examples of rotating mechanism that rotate the guide shafts 32a and 32b on first ends of the guide shafts 32a and 32b on a plane parallel to the surface of the sheet M.

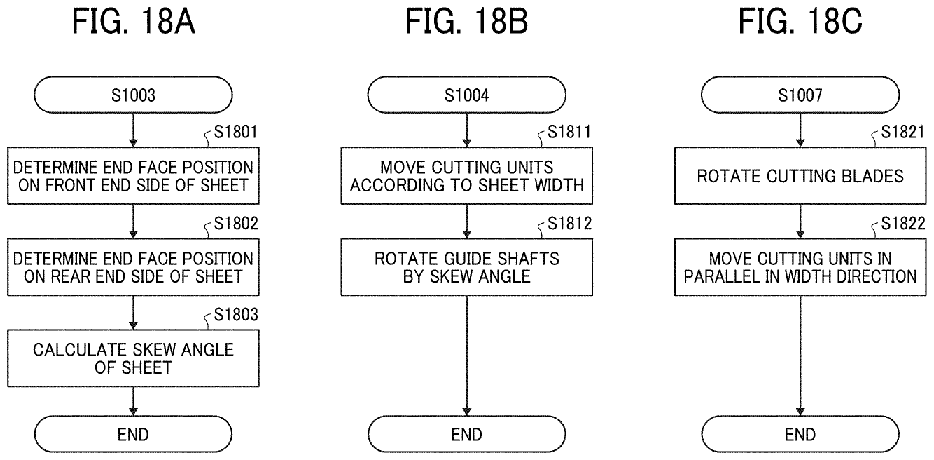

FIGS. 18A to 18C are flowcharts illustrating steps S1003, S1004, and S1007 according to the third embodiment of the chamfering process illustrated in FIG. 10. FIGS. 19A to 19F are diagrams illustrating a positional relationship between the sheet M and the cutting units 33a and 33b in each phase of a chamfering process according to the third embodiment. In the chamfering process according to the third embodiment, steps S1003, S1004, and S1007 are different from the first embodiment, and other steps S1001 and S1002, S1005 and S1006, and S1008 and S1009 are in common with the first embodiment.

In step S1003 of FIG. 10, a controller 100 according to the third embodiment executes steps S1801 to S1803 illustrated in FIG. 18A. In steps S1801 to S1803, the controller 100 determines the end face position of the sheet M at a plurality of locations separated in the conveyance direction, and detects the skew angle (tilt angle) θ of the sheet with respect to the conveyance direction based on the difference between the determined end face positions.

More particularly, as illustrated in FIG. 19A, the controller 100 determines the end face position of the sheet M based on the detection signal from a line sensor 23 at the timing when a first position on the front end side of the sheet M faces the line sensor 23 (S1801). Further, as illustrated in FIG. 19B, the controller 100 determines the end face position of the sheet M based on the detection signal from the line sensor 23 at the timing when a second position of the sheet M closer to the rear end side than the first position faces the line sensor 23 (S1802). The distance between the first position and the second position is determined by the number of pulse signals of the rotary encoder in the motor of the conveyance unit 21.

Next, the controller 100 determines the skew angle θ based on the combination of the difference between the end face positions (first length in the width direction) determined in steps S1801 and S1802 and the distance between the first position and the second position (second length in the conveyance direction) (S1803). More particularly, the skew angle θ refers to, in a right triangle whose two sides making a right angle have the first length and the second length, the angle formed by the side along the conveyance direction and the oblique side. The line sensor 23 and the rotary encoder in the motor of the conveyance unit 21 is an example of the tilt angle detector for detecting the skew angle θ of the sheet M with respect to the conveyance direction.

Further, in step S1004 of FIG. 10, the controller 100 according to the third embodiment executes steps S1811 and S1812 illustrated in FIG. 18B. In steps S1811 and S1812, the controller 100 has two cutting blades 43a facing the front right corner and the front left corner of the skewed sheet M.

First, as illustrated in FIG. 19C, the controller 100 moves the cutting units 33a and 33b according to the width of the sheet M by driving moving motors 34a and 34b (S1811). In step S1811, the moving motor 34a is driven assuming that the sheet M is not skewed. However, at this point, the cutting blades 43a of the cutting units 33a and 33b do not face the front right corner and the front left corner of the sheet M.

Next, as illustrated in FIG. 19D, the controller 100 drives the rotary motor 39 to rotate the guide shafts 32a and 32b by the skew angle θ (S1812). More particularly, the controller 100 rotates the guide shafts 32a and 32b by the skew angle θ in the same direction as the direction of tilt of the sheet M (counterclockwise in the example of FIGS. 19A to 19F) when the cutting device 30B is seen in a plan view. As a result, the cutting blades 43a of the cutting units 33a and 33b face the front right corner and the front left corner of the sheet M.

Further, in step S1007 of FIG. 10, the controller 100 according to the third embodiment executes steps S1821 and S1822 illustrated in FIG. 18C. In steps S1821 and S1822, the controller 100 has two cutting blades 43a facing the rear right corner and the rear left corner of the skewed sheet M.

First, as illustrated in FIG. 19E, by driving the switching motor 48, the controller 100 switches the cutting blade 43a of the cutting unit 33a from the first posture to the second posture and switches the cutting blade 43a of the cutting unit 33b from the third posture to the fourth posture (S1821). Further, the controller 100 moves the cutting units 33a and 33b by the first length by driving the moving motors 34a and 34b (S1822). The moving direction of the cutting units 33a and 33b is a direction from the end face position determined in step S1801 to the end face position determined in step S1802. As a result, the cutting blades 43a of the cutting units 33a and 33b face the rear right corner and the rear left corner of the sheet M.

According to the third embodiment, even when the sheet M is skewed, the four corners of the sheet M can be appropriately chamfered. Further, since the third embodiment is configured by adding only the rotary gear 38, the rotary motor 39, and the drive gear 39a to the cutting device 30 according to the first embodiment, the four corners of the skewed sheet M can be chamfered with the simple configuration.

### Fourth Embodiment

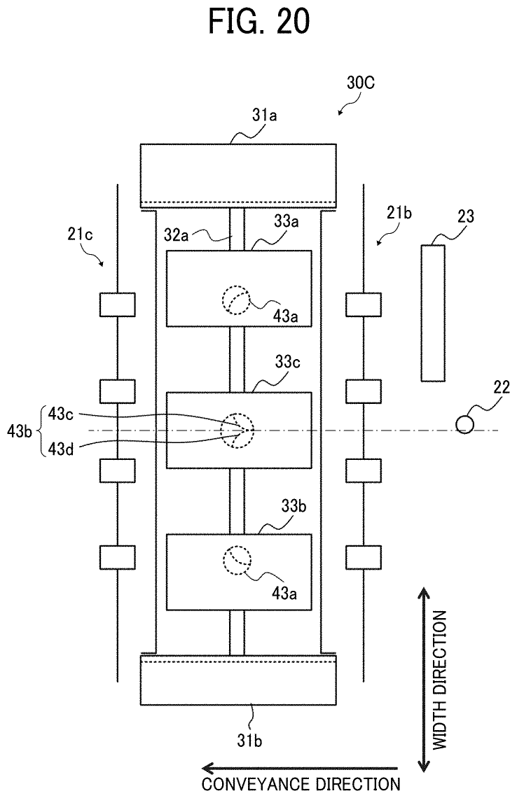

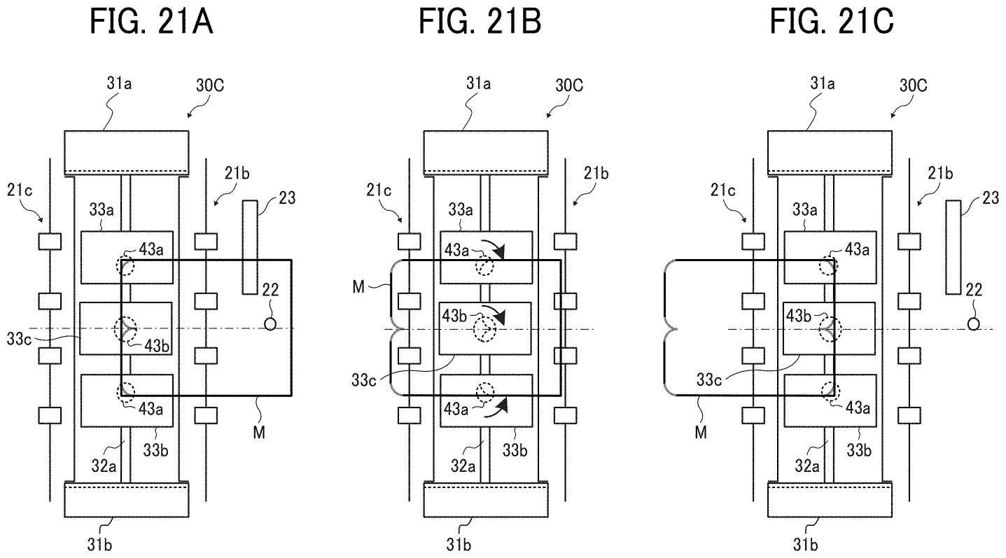

Next, a cutting device 30C according to a fourth embodiment will be described with reference to FIGS. 20 to 21C. FIG. 20 is a plan view of the cutting device 30C according to the fourth embodiment. FIGS. 21A to 21C are diagrams illustrating a positional relationship between a sheet M and cutting units 33a. 33b, and 33c in each phase of a chamfering process according to the fourth embodiment. The detailed description of points in common with the first embodiment will be omitted, and the differences will be mainly described.

The cutting device 30C according to the fourth embodiment is different from the first embodiment in including the three cutting units 33a, 33b, and 33c, and is the same as the first embodiment in other respects. The cutting unit 33a is arranged on one end (right end) side in the width direction, the cutting unit 33b is arranged on the other end (left end) side in the width direction, and the cutting unit 33c is arranged between the cutting units 33a and 33b.

The cutting blades 43a of the cutting units 33a and 33b each have a fan shape with a central angle of 90°. On the other hand, the cutting blade 43b of the cutting unit 33c has a shape with a combination of the first blade 43c and the second blade 43d in the shape of a fan-like arc with a central angle of 90°. More particularly, the first blade 43c and the second blade 43d form the cutting blade 43b with first ends in contact with each other and curved in opposite directions. The cutting blade 43a of the cutting unit 33a is an example of the first blade, the cutting blade 43a of the cutting unit 33b is an example of the second blade, and the cutting blade 43b of the cutting unit 33c is an example of the third blade.

A controller 100 according to the fourth embodiment executes the chamfering process illustrated in FIG. 10. However, the chamfering process according to the fourth embodiment differs from the first embodiment in steps S1004, S1005, S1007, and S1008 in the following points.

First, in step S1004, the controller 100 causes the cutting blade 43a of the cutting unit 33a to face the front right corner of the sheet M, causes the cutting blade 43a of the cutting unit 33b to face the front left corner of the sheet M, and causes the cutting blade 43b of the cutting unit 33c to face the center of the front end of the sheet M, as illustrated in FIG. 21A. At this time, the cutting blade 43a of the cutting unit 33a is in the first posture, and the cutting blade 43a of the cutting unit 33b is in the third posture. The cutting blade 43b of the cutting unit 33c is in a fifth posture in which the first blade 43c is in the third posture and the second blade 43d is in the first posture.

Next, in step S1005, the controller 100 chamfers the front end of the sheet M at the three places by driving respective contact-and-separation motors 45 of the cutting units 33a, 33b, and 33c. When the sheet M is cut along a line extending in the conveyance direction through the center in the width direction, the chamfered portion in the center of the front end of the sheet M will form the front right corner and the front left corner of the two sheets after cutting.

Next, in step S1007, as illustrated in FIG. 21B, by driving the switching motor 48, the controller 100 switches the cutting blade 43a of the cutting unit 33a from the first posture to the second posture, switches the cutting blade 43a of the cutting unit 33b from the third posture to the fourth posture, and switches the cutting blade 43b of the cutting unit 33c from the fifth posture to the sixth posture. The sixth posture is a posture in which the first blade 43c is in the fourth posture and the second blade 43d is in the second posture. That is, the controller 100 rotates the cutting blade 43a of the cutting unit 33a clockwise by 90°, rotates the cutting blade 43a of the cutting unit 33b counterclockwise by 90°, and rotates the cutting blade 43b of the cutting unit 33c by 180°.

When step S1006 is executed, as illustrated in FIG. 21C, the cutting blade 43a of the cutting unit 33a faces the rear right corner of the sheet M, the cutting blade 43a of the cutting unit 33b faces the rear left corner of the sheet M. and the cutting blade 43b of the cutting unit 33c faces the center of the rear end of the sheet M.

Therefore, in step S1008, the controller 100 chamfers the rear end of the sheet M at the three places by driving the respective contact-and-separation motors 45 of the cutting units 33a, 33b, and 33c. When the sheet M is cut along a line extending in the conveyance direction through the center in the width direction, the chamfered portion in the center of the rear end of the sheet M will form the rear right corner and the rear left corner of the two sheets after cutting.

According to the fourth embodiment, not only the four corners of the sheet M but also the corners to be formed when the sheet M is subsequently cut can be chamfered in advance. Further, since the fourth embodiment is configured by adding only the cutting unit 33c to the cutting device 30 of the first embodiment, the above-mentioned processing can be implemented with the simple configuration.

### Fifth Embodiment

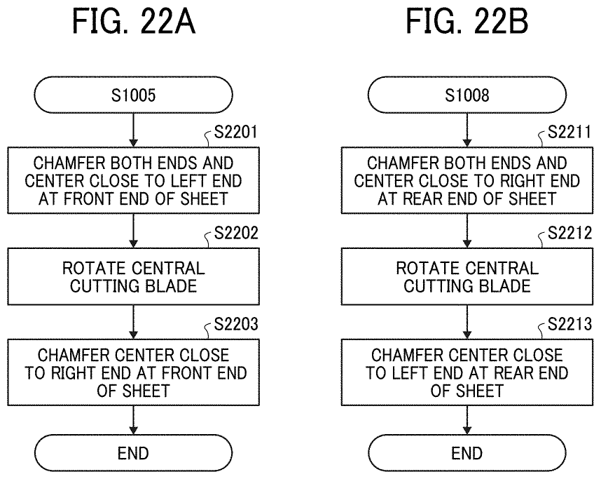

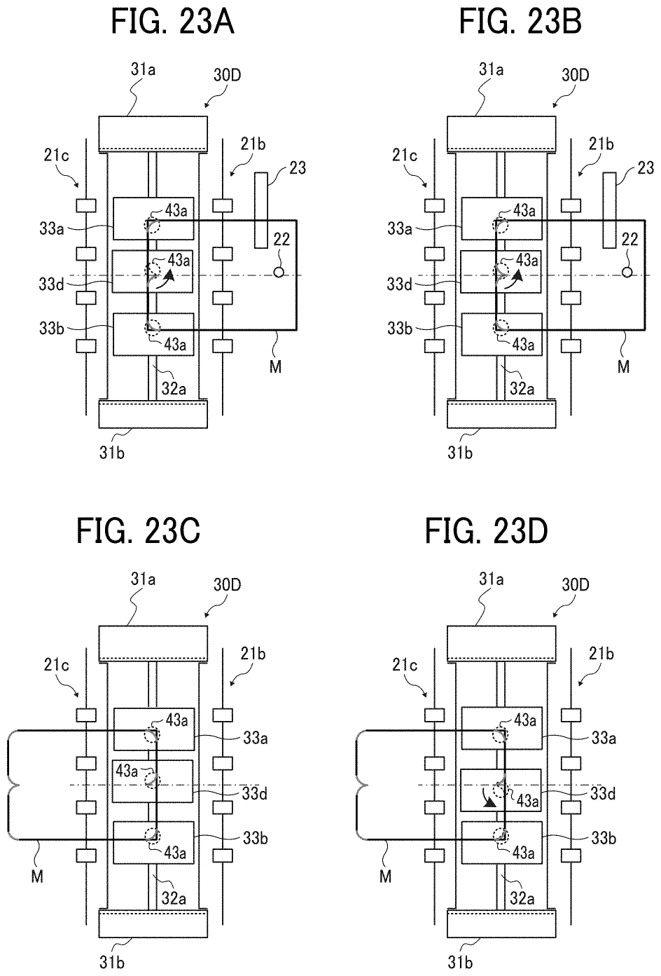

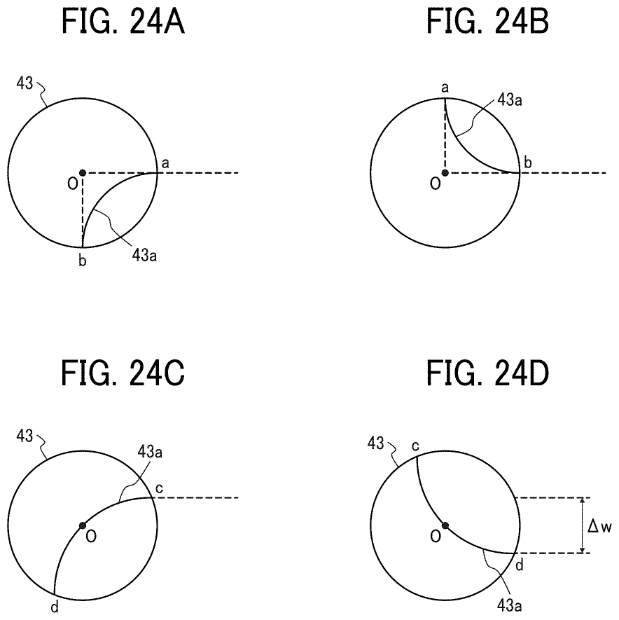

Next, a cutting device 30D according to a fifth embodiment will be described with reference to FIGS. 22A to 24D. FIGS. 22A and 22B are flowcharts illustrating steps S1005 and S1008 according to the fifth embodiment of the chamfering process illustrated in FIG. 10. FIGS. 23A to 23D are diagrams illustrating a positional relationship between a sheet M and cutting units 33a, 33b, and 33d in each phase of the chamfering process according to the fifth embodiment. FIGS. 24A to 24D are diagrams illustrating variations in the shape of a cutting blade 43a. The detailed description of points in common with the first and fourth embodiments will be omitted, and the differences will be mainly described.

As illustrated in FIGS. 23A to 23D, the cutting device 30D according to the fifth embodiment is different from the first embodiment in further including the cutting unit 33d. In addition, a cutting blade 43a of the cutting unit 33d according to the fifth embodiment is different from the fourth embodiment in that it has a fan shape with a central angle of 90°. That is, the cutting units 33a, 33b, and 33d according to the fifth embodiment include cutting blades 43a of the same shape.

In step S1005 of FIG. 10, a controller 100 according to the fifth embodiment executes steps S2201 to S2203 illustrated in FIG. 22A. At the timing when steps S1001 to S1004 in FIG. 10 are completed, the cutting blade 43a of the cutting unit 33a faces the front right corner of the sheet M and is in the first posture, the cutting blade 43a of the cutting unit 33b faces the front left corner of the sheet M and is in the third posture, and the cutting blade 43a of the cutting unit 33d faces the center of the front end of the sheet M and is in the first posture.

First, as illustrated in FIG. 23A, by driving the contact-and-separation motors 45, the controller 100 chamfers the front right corner of the sheet M with the cutting blade 43a (first cutting blade) of the cutting unit 33a, chamfers the front left corner of the sheet M with the cutting blade 43a (second cutting blade) of the cutting unit 33b, and chamfers a vicinity of the center of the front end that is slightly close to the left end of the sheet M with the cutting blade 43a (third cutting blade) of the cutting unit 33d (S2201).

Next, as illustrated in FIG. 23B, the controller 100 switches the cutting blade 43a from the first posture to the third posture by driving the switching motor 48 of the cutting unit 33d (S2202). Then, the controller 100 chamfers a vicinity of the center of the front end that is slightly close to the right end of the sheet M with the cutting blade 43a by driving the contact-and-separation motor 45 of the cutting unit 33d (S2203).

Further, in step S1008 of FIG. 10, the controller 100 according to the fifth embodiment executes steps S2211 to S2213 illustrated in FIG. 22B. At the timing when steps S1006 and S1007 in FIG. 10 are completed, the cutting blade 43a of the cutting unit 33a faces the rear right corner of the sheet M and is in the second posture, the cutting blade 43a of the cutting unit 33b faces the rear left corner of the sheet M and is in the fourth posture, and the cutting blade 43a of the cutting unit 33d faces the center of the rear end of the sheet M and is in the fourth posture.

First, as illustrated in FIG. 23C, by driving the contact-and-separation motors 45, the controller 100 chamfers the rear right corner of the sheet M with the cutting blade 43a of the cutting unit 33a, chamfers the rear left corner of the sheet M with the cutting blade 43a of the cutting unit 33b, and chamfers a vicinity of the center of the rear end that is slightly close to the right end of the sheet M with the cutting blade 43a of the cutting unit 33d (S2211).

Next, as illustrated in FIG. 23D, the controller 100 switches the cutting blade 43a from the fourth posture to the second posture by driving the switching motor 48 of the cutting unit 33d (S2212). Then, the controller 100 chamfers a vicinity of the center of the rear end that is slightly close to the left end of the sheet M with the cutting blade 43a by driving the contact-and-separation motor 45 of the cutting unit 33d (S2213).

According to the fifth embodiment, as in the fourth embodiment, the corners to be formed when the sheet M is subsequently cut can be chamfered in advance. In the fifth embodiment, it is necessary to cut the center of the front end and the center of the rear end of the sheet M twice, which lowers the efficiency of the chamfering process as compared with the fourth embodiment. On the other hand, in the fifth embodiment, the cutting units 33a, 33b, and 33d can have the cutting blades 43a of the same shape, which decreases the number of parts as compared with the fourth embodiment.

When the cutting blade 43a has the shape illustrated in FIG. 24A or 24B, the controller 100 does not need to move the cutting unit 33d in the width direction in steps S2202 and S2212. More particularly, each of the cutting blades 43a illustrated in FIGS. 24A and 24B has a shape in which both ends a and b are in contact with two virtual lines (dotted lines) that pass through a rotation center O of a blade body 43 and are orthogonal to each other on the outer peripheral surface of the blade body 43.

In this case, in step S2201, as illustrated in FIG. 24A, the controller 100 chamfers a vicinity of the center of the front end that is slightly close to the left end of the sheet M with an end portion a aligned with the center of the sheet M in the width direction. Next, in step S2202, the controller 100 only needs to rotate the cutting blade 43a clockwise by 90°. As a result, as illustrated in FIG. 24B, an end portion b of the cutting blade 43a aligns with the center of the sheet M in the width direction. Then, in step S2203, the controller 100 chamfers a vicinity of the center of the front end that is slightly close to the right end of the sheet M.

On the other hand, when the cutting blade 43a has the shape illustrated in FIG. 24C or 24D, the controller 100 needs to move the cutting unit 33d in the width direction in steps S2202 and S2212. More particularly, the cutting blades 43a illustrated in FIGS. 24C and 24D have shapes that pass through the rotation center O of the blade body 43.

In this case, in step S2201, as illustrated in FIG. 24C, the controller 100 chamfers a vicinity of the center of the front end that is slightly close to the left end of the sheet M with an end portion c aligned with the center of the sheet M in the width direction. Next, in step S2202, the controller 100 rotates the cutting blade 43a clockwise by 90°. At this time, as illustrated in FIG. 24D, an end portion d of the cutting blade 43a and the center of the sheet M in the width direction are misaligned by Δw. Therefore, in step S2202, the controller 100 further moves the cutting unit 33d by Δw in the width direction to align the end portion d of the cutting blade 43a with the center of the sheet M in the width direction. Then, in step S2203, the controller 100 chamfers a vicinity of the center of the front end that is slightly close to the right end of the sheet M.

With the shape of the cutting blade 43a illustrated in FIG. 24A or 24B, the movement of the cutting unit 33d in step S2202 can be omitted. On the other hand, the cutting blades 43a illustrated in FIGS. 24A and 24B need to have a larger diameter of the blade body 43 than the cutting blades 43a illustrated in FIGS. 24C and 24D. Steps S2211 to S2213 may be performed according to the above-mentioned process.

### Sixth Embodiment

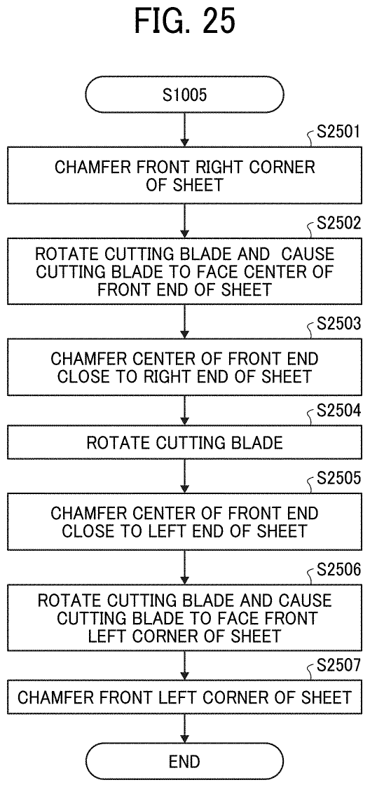

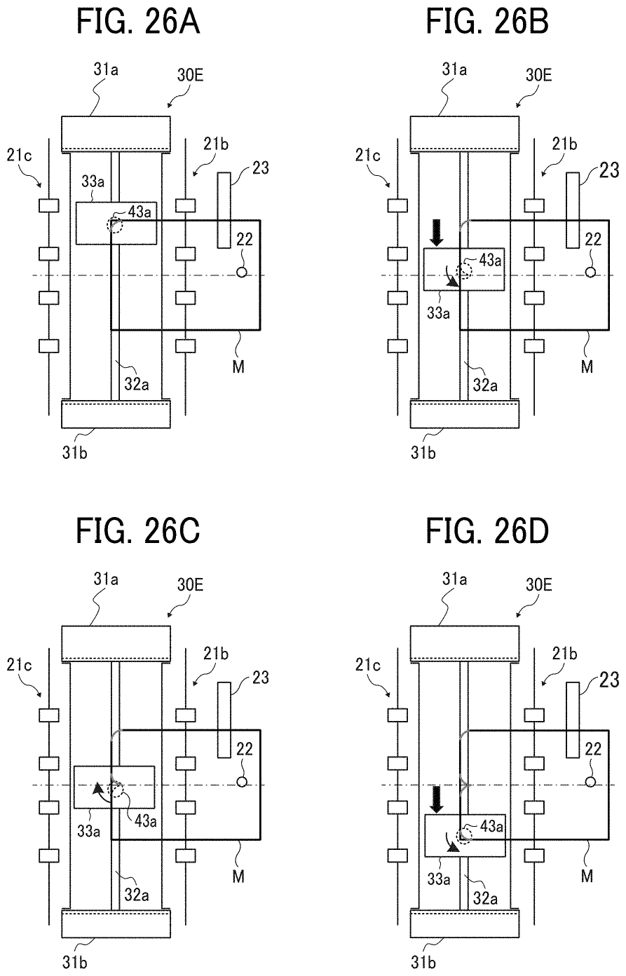

Next, a cutting device 30E according to a sixth embodiment will be described with reference to FIGS. 25 to 26D. FIG. 25 is a flowchart illustrating step S1005 according to the sixth embodiment of the chamfering process illustrated in FIG. 10. FIGS. 26A to 26D are diagrams illustrating a positional relationship between a sheet M and a cutting unit 33a in each phase of the chamfering process according to the sixth embodiment. The detailed description of points in common with the first, second, fourth, and fifth embodiments will be omitted, and the differences will be mainly described. The cutting device 30E according to the sixth embodiment includes only one cutting unit 33a, like the cutting device 30A according to the second embodiment.

In step S1005 of FIG. 10, a controller 100 according to the sixth embodiment executes steps S2501 to S2507 illustrated in FIG. 25. At the timing when steps S1001 to S1004 in FIG. 10 are completed, a cutting blade 43a of the cutting unit 33a faces the front right corner of the sheet M and is in the first posture.

First, as illustrated in FIG. 26A, the controller 100 chamfers the front right corner of the sheet M with the cutting blade 43a by driving a contact-and-separation motor 45 (S2501). Next, as illustrated in FIG. 26B, the controller 100 switches the cutting blade 43a from the first posture to the third posture by driving a switching motor 48, and moves the cutting unit 33a to a position where the cutting blade 43a faces the center of the front end of the sheet M by driving a moving motor 34a (S2502).

Next, the controller 100 chamfers a vicinity of the center of the front end that is slightly close to the right end of the sheet M with the cutting blade 43a by driving the contact-and-separation motor 45 (S2503). Next, as illustrated in FIG. 26C, the controller 100 switches the cutting blade 43a from the third posture to the first posture by driving the switching motor 48 (S2504). Next, the controller 100 chamfers a vicinity of the center of the front end that is slightly close to the left end of the sheet M with the cutting blade 43a by driving the contact-and-separation motor 45 (S2505).

Next, as illustrated in FIG. 26D, the controller 100 switches the cutting blade 43a from the first posture to the third posture by driving the switching motor 48, and moves the cutting unit 33a to a position where the cutting blade 43a faces the front left corner of the sheet M by driving the moving motor 34a (S2506). Next, the controller 100 chamfers the front left corner of the sheet M with the cutting blade 43a by driving the contact-and-separation motor 45 (S2507).

In step S1008 of FIG. 10, the controller 100 according to the sixth embodiment executes steps S2501 to S2507 illustrated in FIG. 25 in the reverse order. That is, the controller 100 chamfers the rear end of the sheet M in the order of the rear left corner, a vicinity of the center slightly close to the left end, a vicinity of the center slightly close to the right end, and the rear right corner.

According to the sixth embodiment, the efficiency of the chamfering process is lower than that of the fourth and fifth embodiments, but the same function can be exhibited with the simpler configuration.

Note that the present disclosure is not limited to specific embodiments described above, and numerous additional modifications and variations are possible in light of the teachings within the technical scope of the appended claims. It is therefore to be understood that, the disclosure of this patent specification may be practiced otherwise by those skilled in the art than as specifically described herein, and such, modifications, alternatives are within the technical scope of the appended claims. Such embodiments and variations thereof are included in the scope and gist of the embodiments of the present disclosure and are included in the embodiments described in claims and the equivalent scope thereof.

Numerous additional modifications and variations are possible in light of the above teachings. It is therefore to be understood that, within the scope of the above teachings, the present disclosure may be practiced otherwise than as specifically described herein. With some embodiments having thus been described, it will be obvious that the same may be varied in many ways. Such variations are not to be regarded as a departure from the scope of the present disclosure and appended claims, and all such modifications are intended to be included within the scope of the present disclosure and appended claims.

1. A cutting device configured to cut, in an arc shape, an end of a sheet conveyed in a conveyance direction, the cutting device comprising:
an arc-shaped cutting blade;
a switching mechanism configured to switch a posture of the cutting blade in accordance with a position of the sheet facing the cutting blade; and
a contact-and-separation mechanism configured to bring the cutting blade into contact with the sheet in a contact direction orthogonal to a surface of the sheet and away from the sheet in a separation direction opposite the contact direction, to cut the end of the sheet in the arc shape.

2. The cutting device according to claim 1,
wherein the switching mechanism is configured to rotate the cutting blade around a rotation axis extending in the contact direction.

3. The cutting device according to claim 2, further comprising:
a first cutting blade positioned on one end side in a width direction orthogonal to the conveyance direction, the contact direction, and the separation direction; and
a second cutting blade positioned on another end side in the width direction,
wherein the first cutting blade has a fan shape with a central angle of 90° and is switchable between a first posture to chamfer, in an arc shape, a corner of a front end of the sheet in the conveyance direction on the one end side and a second posture to chamfer, in an arc shape, a corner of a rear end of the sheet in the conveyance direction on the one end side, and
the second cutting blade has a fan shape with a central angle of 90° and is switchable between a third posture to chamfer, in an arc shape, a corner of the front end of the sheet on said another end side and a fourth posture to chamfer, in an arc shape, a corner of the rear end of the sheet on said another end side.

4. The cutting device according to claim 3, further comprising
a third cutting blade positioned between the first cutting blade and the second cutting blade and having a fan shape with a central angle of 90°,
wherein the third cutting blade is switchable among:
a first posture, identical to the first posture of the first cutting blade, in which the third cutting blade chamfers a vicinity of a center of the front end that is slightly close to said another end side of the sheet;
a second posture, identical to the second posture of the first cutting blade, in which the third cutting blade chamfers a vicinity of a center of the rear end that is slightly close to said another end side of the sheet;
a third posture, identical to the third posture of the second cutting blade, in which the third cutting blade chamfers a vicinity of the center of the front end that is slightly close to the one end side of the sheet; and
a fourth posture, identical to the fourth posture of the second cutting blade, in which the third cutting blade chamfers a vicinity of the center of the rear end that is slightly close to the one end side of the sheet.

5. The cutting device according to claim 3, further comprising
a third cutting blade positioned between the first cutting blade and the second cutting blade, the third cutting blade including a first blade of a fan shape with a central angle of 90° and a second blade of a fan shape with a central angle of 90°,
wherein the third cutting blade has a shape in which one end of the fan shape the first blade and one end of the fan shape of the second blade contact each other and the fan shape of the first blade and the fan shape of the second blade are curved in opposite directions, and
the third cutting blade is switchable between a fifth posture in which the first blade is in a posture identical to the third posture of the second cutting blade and the second blade is in a posture identical to the first posture of the first cutting blade to chamfer a center of the front end of the sheet and
a sixth posture in which the first blade is in a posture identical to the fourth posture of the second cutting blade and the second blade is in a posture identical to the second posture of the first cutting blade to chamfer the center of the rear end of the sheet.

6. The cutting device according to claim 2,
wherein the switching mechanism includes:
a switching motor;
a rotary gear configured to rotate around a rotation axis extending in the contact direction; and
a pin configured to cause the cutting blade inserted into the rotary gear to integrate with the rotary gear.

7. The cutting device according to claim 1,
wherein the contact-and-separation mechanism includes:
a contact-and-separation motor;
a cam configured to rotate with a transferred driving force of the contact-and-separation motor; and
a cam guide configured to, while supporting the cutting blade, reciprocate in the contact direction and the separation direction along with rotation of the cam.

8. The cutting device according to claim 1, further comprising:
a cutting unit holding the cutting blade, the switching mechanism, and the contact-and-separation mechanism;
a guide shaft supporting the cutting unit and extending in a width direction orthogonal to the conveyance direction, the contact direction, and the separation direction; and
a moving mechanism configured to move the cutting unit along the guide shaft.

9. The cutting device according to claim 8,
wherein the guide shaft supports a plurality of cutting units, including the cutting unit, at positions spaced apart in the width direction, and
the moving mechanism is configured to independently move the plurality of cutting units.

10. The cutting device according to claim 8, further comprising a rotating mechanism configured to rotate the guide shaft on one end of the guide shaft on a plane parallel to the conveyance direction and the width direction.

11. A post-processing apparatus comprising:
a conveyor configured to convey a sheet in a conveyance direction;
the cutting device according to claim 2, configured to cut, in the arc shape, an end of the sheet conveyed by the conveyor;
a sheet position detector configured to detect a position of the sheet conveyed by the conveyor;
a rotation angle detector configured to detect a rotation angle of the cutting blade; and
control circuitry configured to control an operation of the cutting device based on a detection result of the rotation angle detector and a detection result of the sheet position detector,
wherein the control circuitry is configured to:
cause the conveyor to convey the sheet, based on the detection result of the sheet position detector, such that a cutting position of the sheet faces the cutting blade; and
cause the switching mechanism to switch a posture of the cutting blade, based on the detection result of the rotation angle detector, such that the cutting blade is in a posture corresponding to the cutting position, and cause the contact-and-separation mechanism to bring the cutting blade in the posture corresponding to the cutting position into contact with and away from the sheet.

12. The post-processing apparatus according to claim 11,
wherein the control circuitry is configured to:
cause the conveyor to convey the sheet such that a corner on a front end side of the sheet in the conveyance direction faces the cutting blade;
cause the contact-and-separation mechanism to bring the cutting blade in a posture corresponding to the corner on the front end side of the sheet into contact with and away from the sheet;
cause the conveyor to convey the sheet such that a corner on a rear end side of the sheet in the conveyance direction faces the cutting blade;
cause the switching mechanism to switch the posture of the cutting blade such that the posture corresponds to the corner on the rear end side of the sheet; and
cause the contact-and-separation mechanism to bring the cutting blade in the posture corresponding to the corner on the rear end side of the sheet into contact with and away from the sheet.

13. A post-processing apparatus comprising:
a conveyor configured to convey a sheet in a conveyance direction;
the cutting device according to claim 10, configured to cut, in the arc shape, an end of the sheet conveyed by the conveyor;
a tilt angle detector configured to detect a tilt angle of the sheet with respect to the conveyance direction; and
control circuitry configured to control an operation of the cutting device based on a detection result of the tilt angle detector,
wherein the control circuitry is configured to cause the rotating mechanism to rotate the guide shaft by the tilt angle detected by the tilt angle detector.

14. An image forming system comprising:
an image forming apparatus configured to form an image on a sheet;
a conveyor configured to convey the sheet with the image formed by the image forming apparatus in a conveyance direction; and
a post-processing apparatus including the cutting device according to claim 1.
